(19) United States
(12) Patent Application Publication
(10) Pub. No.: US 2019/0066238 A1
(43) Pub. Date: Feb. 28, 2019

(54) SYSTEM AND COMPUTER PROGRAM FOR OPTIMIZED EXECUTION IN A VALUE CHAIN NETWORK

(71) Applicants: Ranjit Notani, Plano, TX (US); Greg Brady, Dallas, TX (US); Adeel Najmi, Plano, TX (US); Eric Rodriguez, Hurst, TX (US)

(72) Inventors: Ranjit Notani, Plano, TX (US); Greg Brady, Dallas, TX (US); Adeel Najmi, Plano, TX (US); Eric Rodriguez, Hurst, TX (US)

(73) Assignee: One Network Enterprises, Inc., Dallas, TX (US)

(21) Appl. No.: 15/683,764

(22) Filed: Aug. 22, 2017

(51) Int. Cl. G06Q 50/12; G06Q 30/02; G06Q 10/06

(52) U.S. Cl. CPC G06Q 50/12; G06Q 30/0633; G06Q 10/06315; G06Q 30/0202

(57) ABSTRACT

A system, computer program product and method for optimized execution in a value chain network. The value chain network has shared access to a shared database on a service provider computer over a network. The computer program product and method receives a request for an order for goods or services from a first company in the value chain network, searches for one or more second companies having matching goods or services in the value chain network, sources the matched one or more second companies, creates a plan over one or more segments to effect the movement of the good or services, involves one or more third companies, from a source location to a destination location, manages the handoffs between the relevant first, second and third companies in order to ship the goods or services, determines demand for the goods or services from the first company in the value chain network, receives changes or anomalies to the plan over one or more segments, and optimizes execution of the plan during its execution.

### BACKGROUND OF THE INVENTION

### Field of the Invention

The present invention is generally related to enterprise value chains, and more particularly to a system and computer program for optimized execution in a value chain network.

### Discussion of the Background

In an increasingly global economy, there is a need for computer networks to share information between computer applications and to better adapt to meet the needs of the business enterprise(s) and computer applications using such networks. Business enterprises of all types are faced with the challenge of managing and optimizing ever more complex supply chains. These supply chains, often called “value chains,” are characterized by a high degree of collaboration, cooperation, and interdependency between the enterprise and other entities or partners in the chain (e.g., raw materials producers, component manufacturers, distributors, and the like). The business goal of managing and optimizing a value chain is to minimize the costs incurred by all participants in the chain while maintaining a high level of customer service and maximizing profits. In order to achieve this goal, the enterprise strives to reduce the quantity of stored goods in the value chain, while minimizing opportunity loss by maintaining a sufficient inventory level to satisfy customer demand.

A typical value chain and/or supply chain may span multiple companies and/or entities and sometimes include hundreds or even thousands of companies and/or entities. In the prior art, each company and/or entity maintained its own separate value chain system. In particular, each company and/or entity maintained its own value chain network locally on its own computer systems, databases and computer programs associated with the value chain network. Even with so-called multi-tier or multi-echelon systems known in the prior art, each company and/or entity maintained its own multi-tier or multi-echelon system. The companies would then typically communicate with other companies in the value chain via exchange messages (typically EDI). These techniques are inherently flawed. According to the prior art, each company had to potentially integrate their own internal value chain with many if not all of the other companies in the value chain leading to n² integrations, where ‘n’ is the number of companies in the value chain. Such an arrangement required additional time and expense in setting up and managing the value chain, and was highly coupled. Due to the high degree of coupling in the prior art, any changes in the value change typically resulted in extensive modifications throughout the value chain. Due to the size and complexity of most value chains, schedule-driven and batch processing value chain management systems of the prior art often resulted in stale or out of date data being used. This led to expensive reconciliation and significantly limited the types of processes that could be executed. It was also difficult if not impossible to deploy new multi-company processes using the techniques known in the prior art. Further, visibility beyond a company's immediate neighbors was problematic because multi-tier visibility was difficult if not impossible to obtain and to orchestrate.

To meet customer demand, enterprises, such as, without limitation, stores and other retail entities, forecast the future demand of their customers, including, without limitation, other enterprises, the general public and other entities or persons to which the enterprise serves or has a relationship. A sales forecast is utilized to, amongst other things, manage resources, including, without limitation, ensuring that the appropriate amount of inventory and resources are available when and where they are needed. An execution plan may be generated based on the demand shown in the sales forecast. An execution plan typically specifies the movement and placement of inventory and resources, and includes a plurality of actions that need to be taken to maintain inventory at a certain level.

In the prior art, planning engines are run in a batch mode in which all of the information relating to the value chain network is provided to the planning engine. Based on this input, planning engines known in the prior art generate a plan or model which takes significant computer resources. For instance, a typical execution plan may take 8 to 10 hours or possibly longer depending on the amount of information to be processed. Notably, the planning engines are run, and the generated plan is generated, prior to and separate from the execution stage. The information that is fed into the planning engines known in the prior art is at least in theory the then-current information or state when the planning engine was run. However, in reality, given the multiple systems involved there is no guarantee that the most current information is even incorporated into the planning engine. Because the planning engines known in the prior art created a plan for everything before the execution, the plan necessarily included significant time padding. For instance, there are numerous unknowns at the planning stage when the plan is first created and therefore execution plans known in the prior art included time padding for these unknowns. Further, value networks include multiple companies and each company may include multiple divisions and systems. Execution plans known in the prior art included time padding for each handoff between each company and often between each division and system within a company. Such time paddings create huge inefficiencies and unnecessary downtime. It also necessitates additional expenses such as premium freight costs and requirements of additional stock to reduce out-of-stock situations caused by the inefficiencies of the execution plan.

As previously noted, planning engines known in the prior art are run prior to and completely separate from the execution stage. The generated execution plan and the related state information would then be input into a different engine or model and everything would be copied over and then sent over to the execution engine. Such an arrangement resulted in significant inefficiencies and redundant network traffic and computer execution.

Thus, there currently exist deficiencies associated with enterprise value chain logistics planning, and, in particular, with optimized execution in a value chain network.

### SUMMARY OF THE INVENTION

Accordingly, one aspect of the present invention is to provide a computer program product embodied on a non-transitory computer readable medium for optimized execution of handling raw product components used by a restaurant in a value chain network. The value chain network having shared access to a shared database on a service provider computer over a network. The computer program is implemented by one or more processors executing processor instructions. The computer program product includes (i) a first computer code for determining consumer traffic at a restaurant in the value chain network; (ii) a second computer code for determining demand for one or more menu items from the restaurant in the value chain network; (iii) a third computer code for determining demand for one or more raw product components associated with the one or more menu items from the restaurant in the value chain network; (iv) a forth computer code for receiving a request for an order for the one or more raw product components from the restaurant in the value chain network; (v) a fifth computer code for searching for one or more suppliers having matching one or more raw product components in the value chain network; (vi) a sixth computer code for sourcing the matched one or more suppliers; (vii) a seventh computer code for creating a plan over one or more segments to effect the movement, involving one or more carriers, of the one or more raw product components from a source location to a destination location; (viii) an eighth computer code for managing the handoffs between the restaurant, the one or more suppliers and the one or more carriers in order to ship the one or more raw product components; (ix) a ninth computer code for receiving changes or anomalies to the plan over one or more segments; and (x) a tenth computer code for optimizing execution of the plan during its execution. Determining the demand for the one or more menu items utilizes the determined consumer traffic. Determining the demand for the one or more raw product components utilizes the determined demand for the one or more menu items.

Another aspect of the present invention is to provide a computer program product embodied on a non-transitory computer readable medium for optimized execution in a value chain network. The value chain network has shared access to a shared database on a service provider computer over a network. The computer program is implemented by one or more processors executing processor instructions. The computer program product includes (i) a first computer code for receiving a request for an order for goods or services from a first company in the value chain network; (ii) a second computer code for searching for one or more second companies having matching goods or services in the value chain network; (iii) a third computer code for sourcing the matched one or more second companies; (iv) a fourth computer code for creating a plan over one or more segments to effect the movement of the good or services from a source location to a destination location; (v) a fifth computer code for managing the handoffs between the relevant first, second and third companies in order to ship the goods or services; (vi) a sixth computer code for determining demand for the goods or services from the first company in the value chain network; (vii) a seventh computer code for receiving changes or anomalies to the plan over one or more segments; and (viii) an eight computer code for optimizing execution of the plan during its execution. The movement involves one or more third companies.

Yet another aspect of the present invention is to provide a system for optimized execution in a value chain network. The system includes a plurality of remote computers, a central server, a network interface in communication with the central server and the plurality of remote computers over a network, and a shared database in communication with the central server. The network interface is configured to receive one or more transactions via the network. The value chain network has shared access to a shared database on a service provider computer over a network via a database router module. The central server is configured to (i) receive a request for an order for goods or services from a first company in the value chain network; (ii) search for one or more second companies having matching goods or services in the value chain network; (iii) source the matched one or more second companies; (iv) create a plan over one or more segments to effect the movement of the good or services from a source location to a destination location; (v) manage the handoffs between the relevant first, second and third companies in order to ship the goods or services; (vi) determine demand for the goods or services from the first company in the value chain network; (vii) receive changes or anomalies to the plan over one or more segments; and (viii) optimize execution of the plan during its execution. The movement involves one or more third companies.

### BRIEF DESCRIPTION OF THE DRAWINGS

A more complete appreciation of the present invention and many of the attendant advantages thereof will be readily obtained as the same becomes better understood by reference to the following detailed description when considered in conjunction with the accompanying drawings, wherein:

FIG. 1A is a block diagram illustrating an exemplary value chain network (or portion thereof) in accordance with an embodiment of the present invention;

FIG. 1B is a block diagram illustrating the processing flow of different processing engines in a value chain network known in the prior art;

FIG. 1C is a block diagram illustrating the processing flow of different processing engines in a value chain network in accordance with an embodiment of the present invention;

FIG. 1D is a block diagram illustrating exemplary representative functional areas and enterprises in a value chain network in accordance with an embodiment of the present invention;

FIG. 2A is a block diagram illustrating an exemplary database arrangement for a value chain network in accordance with an embodiment of the present invention;

FIG. 2B is a block diagram illustrating the optimized execution engine's relationship with other engines in a value chain network in accordance with an embodiment of the present invention;

FIGS. 3A-3G are flow charts illustrating a method for optimized execution in a value chain network in accordance with an embodiment of the present invention;

FIGS. 4A-4I are flow charts illustrating a method for optimized execution of handling raw product components used by a restaurant in a value chain network in accordance with an embodiment of the present invention; and

FIG. 5 illustrates a portion of a computer-based system in a value chain network in accordance with an embodiment of the present invention.

### DETAILED DESCRIPTION OF THE PREFERRED EMBODIMENTS

Referring now to the drawings, wherein like reference numerals designate identical or corresponding parts throughout the several views, preferred embodiments of the present invention are described.

The first implementation of the present invention is a consumer driven system for the food service industry. According to this implementation, the present invention forecasts consumer traffic at a restaurant. Based on that forecast consumer traffic, the system forecasts the demand for menu items that are offered by the restaurant, and the raw material components necessary to make those menu items. The system determines which raw materials components to buy; how to cut the raw material components; how to package the raw material components; how to ship the raw material components; how to prep the raw material components; and how to sell the raw material components. The system uses optimized execution to keep the forecast current based on real-time input from the restaurant and along the value chain.

The second implementation of the present invention is an automated system for optimized execution using a demand profile for one or more products. According to this implementation, a retailer has a demand for one or more products and wants to purchase those products from one or more suppliers.

In the prior art, the retailer would request an order of a product of particular quantity from a supplier. The order request is sent to the supplier. Upon receipt of the order request, the supplier either agrees to the requested quantity or counters with a case-cut. Once the quantify of the order and the desired delivery date are agreed to, a shipment is created. The shipment is tendered by the retailer or the supplier. When the shipment is tendered, a purchase order is created for a carrier. Upon receipt of the purchase order, the carrier requests an optimized schedule around the due date of the order. Managed by at least three individuals (e.g., the buyer, the seller and the carrier) and possibly more (e.g. 3PL and an outsourced distribution center).

According to the present invention, takes the demand for a product, which may be an order, and automatically optimizes its execution. The system automatically determines the appropriate optimized date and time of the day in which the order should be delivered and an optimized location, such as the dock door, where the order should be delivered. The order is sent to the supplier with the order already optimized for delivery. A shipment is then automatically tendered and a purchase order is created sent to a carrier with the date and time already on it. It optimizes all of the capacities and those capacities are your distribution. It optimizes the carrier and the supplier pickup times.

The present invention also automatically optimizes changes to the order. Assume, for instance, that a retailer originally ordered a quantity of 1000 units of product A and 500 units of product B, each to be delivered in two days. However, after the order, the retailer sold more units of product A than expected and less units of product B after the original order. Based on that demand, let's assume that the retailer now needs 2000 units (instead of 1000 units) of product A and now doesn't need any units of product B. In the prior art, the capacity of the order would be incorrect and the retailer would have too few units of product A delivered and too many units of product B delivered. In this scenario, product A would result in an out of stock situation while product B would result in an overstock situation. The present invention, looks at the demand profile and not just the order, and if the order for product A and/or product B has not yet left the dock of the supplier, then the system automatically notifies the carrier and supplier to either not send or reduce the quantity for product B and to increase the quantity for product A. Said another way, the system automatically takes some of the unneeded capacity for product B and gives that capacity to product A.

The system may also delay or expedite the shipment of a product based on its demand profile. For instance, the shipment of product B may be delayed for some period of time to take into consideration the retailer's lower than expected demand for product B. So instead of shipping product B on, for instance, Monday, the system may automatically notify the carrier and supplier that the order for product B will be shipped on, for instance, Wednesday. The system may also automatically expedite the shipment date and time of product A to take into consideration the retailer's higher than expected demand of product A. in this case, the carrier and supplier may be automatically notified that the order for product A will be shipped on, for instance, Monday instead of Tuesday

As is known in the freight shipping industry, most distribution centers are often choke points with regards to shipping. Trucks sometimes wait for hours just to be unloaded. However, when a carrier reaches a destination, a carrier may either unload an order at a dock door or just drop the trailer in the yard to be unloaded later. The present invention automatically optimizes the execution of the shipment based on the demand profile and/or other factors, such unloading wait times at distribution centers. For instance, assume that an order was originally scheduled to be unloaded at a dock door at particular date and time by a carrier. Based on the demand profile, the present invention may automatically notify the carrier before or during shipment to instead drop the trailer in the yard so that the order will be unloaded at a later time. Using such execution optimization, distribution center bottleneck situations are reduced and the execution of the shipment is adjusted in real-time as the need arises. This eliminates the need to manually coordinate such changes to the shipment with the supplier, carrier and distribution centers and reduces the shipping time by days.

### Purchase Order Generation

As part of the purchase order generation and confirmation process, the present invention automatically creates a pre-ASN, purchase order priority, and the delivery appointment at the receiving location. According to the present invention, buyers are provided a graphical user interface to the value chain network 100. Using this graphical user interface, buyers have access to the capacity view at the delivery location. Buyers can update the priority on a purchase order manually based on the replenishment process. Capacity reservations are derived based on the content using variable load settings or by partner profiles or commodity codes.

### Purchase Order to Supplier

The present invention automatically creates the pickup appointment schedule for the supplier related to a purchase order. According to the present invention, suppliers are provided a graphical user interface to the value chain network 100. Using this graphical user interface, suppliers can schedule and update pickup appointments along with the pre-ASN associated with the purchase order. The value chain management system 114 is configured to send notifications to the buyer when the pickup appointment information is initially created or updated. As part of the inventory issue or pick and pack operation process, the present invention may communicate an EDI 855. The supplier may also login to the value chain network 100 and to perform a confirmation. The buyer may be configured using a graphical user interface to subscribe to alerts for order confirmations or changes.

### Tender Status

According to the present invention, buyer or supplier transportation manager are provided a graphical user interface to the value chain network 100. The buyer or supplier transportation manager uses the graphical user interface to collaborate with the carrier to tender shipment freight cost offers. The carrier can accept or reject the tenders. The value chain management system 114 automatically calculates the freight costs based on the content and other service level requirements, where the complexity of the purchase order is used in the calculation. Tendering policies may be configured based on the criticality of the purchase order in terms of rotational allocation across dedicated carrier capacity or as spot tenders.

### Carrier Status and In-Transit Management

The value chain management system 114 automatically sends pickup and in-transit notifications by any known means, including EDI 214 messages. A graphical user interface to the value chain network 100 is provided for users to update the pickup and in-transit status. In-transit freight may include onboard sensing device equipment. The output from the onboard sensing device equipment may be automatically received by the value chain management system 114 by means of any known communication, including EDI 214 messages. The value chain management system 114 automatically sends supplier quantity cut notifications at the time of pickup by any known means, including EDI 856 messages. Using the graphical user interface, buyers can update the priority on purchase orders and subscribe to receive notifications relating to carrier status and in-transit management of the freight.

### Gait-In and Load/Yard Management

The value chain management system 114 automatically captures gate-in and gait-out information, trailer position within the yard information and trailer detention time information. The trailer and its current inventory can be tracked as it moves along with shunting operations.

### Unloading and Receiving Process

As the unload operations progress, the value chain management system 114 automatically captures the unloaded freight. Receipt tracking events as well as quality assurance information are captured. This information may be automatically received by the value chain management system 114 by means of any known communication, including EDI 214 message. Any quality issues are maintained by the value chain management system 114 such that buyers and vendors can collaborate in any claim or settlement.

It is often important to share the most current information between computer applications over a computer network. Information may be shared between computer applications using either (a) a single version of the truth, or (b) multiple versions of the truth. As used herein, a “single version of the truth” is an arrangement in which the same data in its most current/updated form is accessible by multiple computer applications and/or multiple parties. In order to maintain a single version of truth, any single data element is generally represented in a single location. Conversely, multiple versions of the truth are stored in multiple locations. However, in situations where there are multiple versions of the truth, each of the locations must be updateable simultaneously. Otherwise, by definition, there are at least temporary inconsistencies with respect to the representation of the data. In that case, the information may or may not be the most current. In practice, multiple versions of the truth with simultaneous updating is generally not feasible and a non-stale system cannot be built on such a representation. According to at least one embodiment of the present invention, a single version of the truth is utilized for at least a portion of the information relevant to sales forecasting.

The present invention may utilize or more computer applications. As used herein, a “computer application” is a computer executable software application of any type that executes processing instructions on a computer or embedded in a processor, and an “application” or “application project” are the files, objects, structures, database resources and other resources used in integrating a computer application into a software platform.

The term “database” as used herein means a collection of data and is not limited to a relational database or even disk based storage. It includes, without limitation, relational databases, memcache, Hadoop, or any other collection of data now known or developed in the future.

### Processing Flows

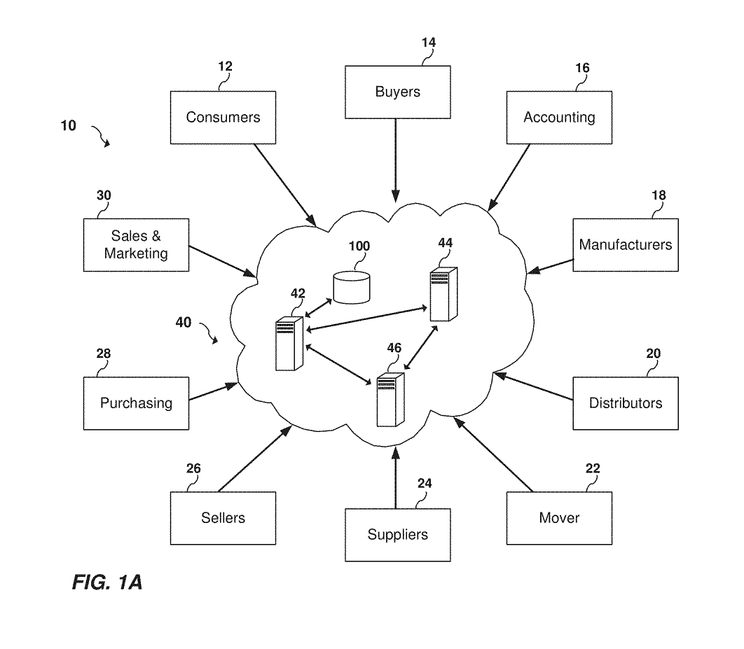

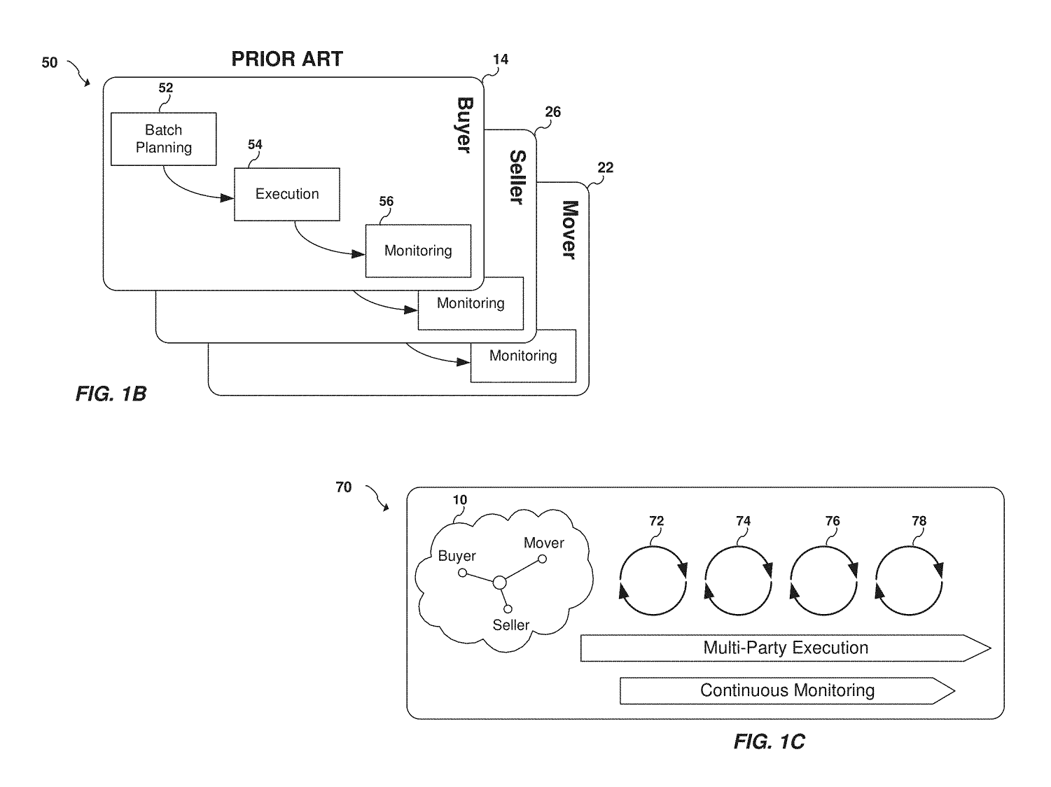

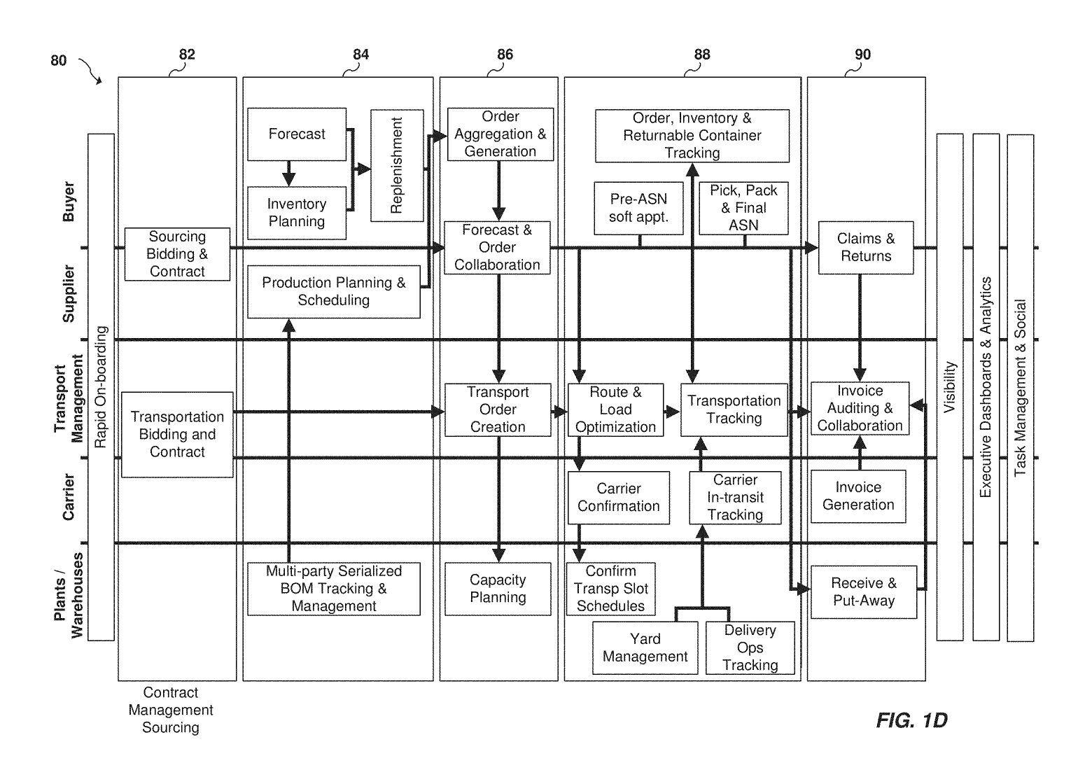

Referring to FIG. 1C, a block diagram illustrating the processing flow of different processing engines in a value chain network in accordance with an embodiment of the present invention, is shown.

Unlike the prior art, the present invention makes plan modifications and decisions as the system executes or said another way during the execution phase. The decision-making engines are embedded within and are a part of the execution platform itself. The plan and decisions are therefore always current with the execution data because they utilize the most recent state information. As the state changes, the plan and decisions are modified to accommodate and better tune the plan to the most current information available. The prior art could not do this for a variety of reasons. For instance, because the prior art generated a plan for the entire value network which takes significant time, it would be unreasonable and inefficient to re-run the planning engine again during execution when changes or anomalies occur. The present invention solves this problem by using net change and incremental execution optimization. According to one embodiment, changes or anomalies are net change and incremental, and are limited to the portion of the plan which is affected. Decisions are made with as little data or as much data as needed. For instance, if there is a problem with Texas, then just update the optimize the execution associated with Texas. According to one embodiment, this may be referred to herein as a sub-network. Utilizing sub-networks to handle incremental changes significantly reduces the processing required to update the plan. Further, updating the entire plan introduces additional problems such as introducing nervousness with regards to reliable dates associated with different portions of the plan. The use of sub-networks minimizes the effect of incremental changes throughout the value chain and thereby reduces nervousness with regards to the reliable dates.

There are numerous benefits associated with embedding the decision making and continuously optimizing the plan within the execution platform. Unlike the prior art, no data need to be copied back and forth between separate engines. You can only execute the plan because the plan always reflects the current state information. If there are any problems during the execution of the plan, the problems are apparent earlier than systems known in the prior art. Further, because there is more information available during the execution phase and the present invention continually optimizes the execution of the plan, time padding is virtually eliminated. Because changes to the plan are net change and incremental, updating and refining the execution plan is significantly faster than the separate engines known in the prior art.

Excess demand at a location promotional sale. Unexpected stock-out at a location. Historically you have to jump thru hoops. The state information used in the execution plan known in the prior art utilizes inherently stale information. Depending on how much time has elapsed since the planning engine was run, the state information utilized during execution by the prior art may be stale by hours, days or possibly longer. If you need reroute a truck. If you need to order supplementary products. If you need to source from a second-tier stocking location because of weather conditions at the first-tier stocking location. The closer the execution is to planning the more accurate and refined is the plan.

Referring to FIG. 1D, a block diagram illustrating exemplary representative functional areas and enterprises in a value chain network in accordance with an embodiment of the present invention, is shown.

Exemplary block diagram showing representative functional areas and enterprises in a value network. As shown in this figure, unlike the prior art, different functional areas and enterprises are on the same network. The vertical columns represent different functional areas. The horizontal lines represent different enterprises.

The present invention introduces a “pre-ASN”, also referred to as a “transport order” herein. A pre-ASN as used herein is unique to the present invention and different to anything used in the prior art.

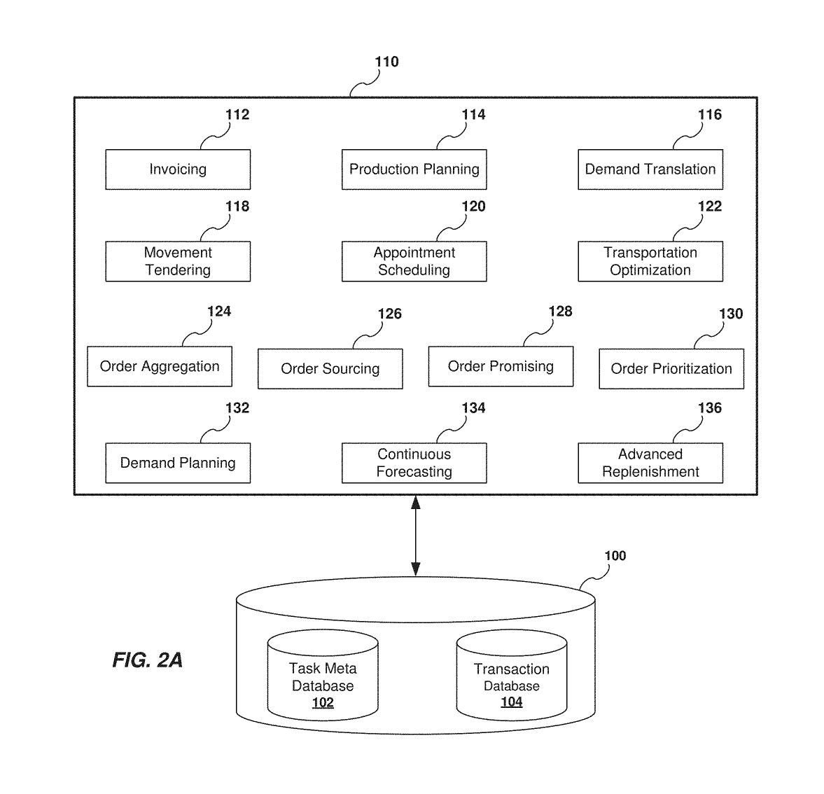

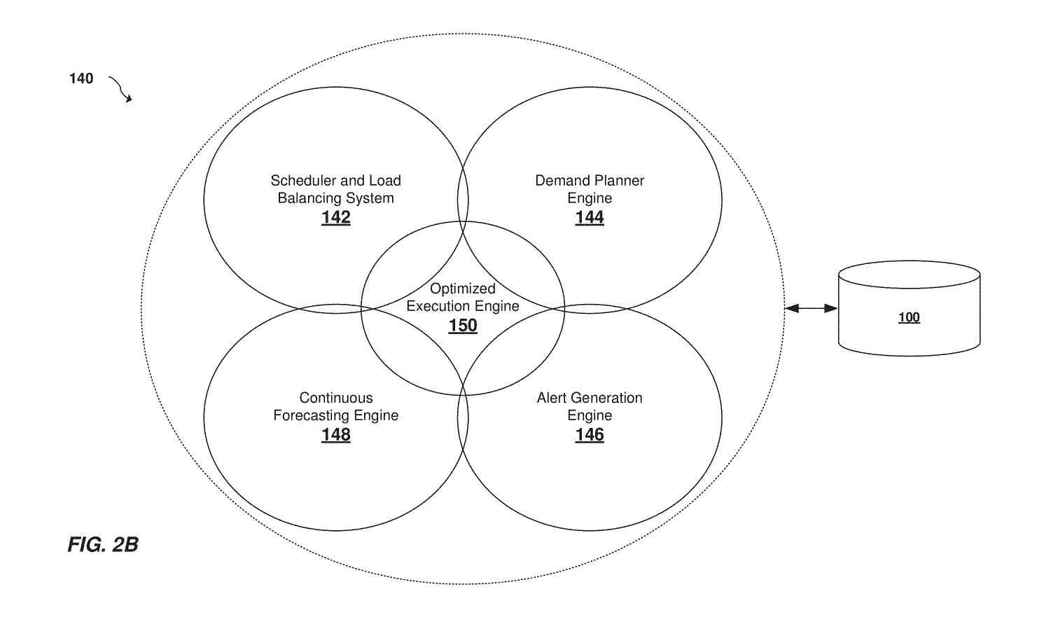

Referring to FIG. 2A, a block diagram illustrating an exemplary database arrangement for a value chain network in accordance with an embodiment of the present invention, is shown.

Referring to FIG. 1B, a block diagram illustrating the processing flow of different processing engines in a value chain network known in the prior art, is shown. The prior used a waterfall in the execution of its batch planning, execution and monitoring. Unlike the prior art, the present invention makes plan modifications and decisions during the execution phase. The decision-making engines are embedded within and are a part of the execution platform itself. As the state changes, the plan and decisions are modified to accommodate and better tune the plan to the most current information available.

Referring to FIG. 2B, a block diagram illustrating the optimized execution engine's relationship with other engines in a value chain network in accordance with an embodiment of the present invention, is shown. As shown, the optimized execution engine 150 is in communication with all relevant engines, including, without limitation, scheduler and load balancing system 142, demand planner engine 144, alert generation engine 146 and continuous forecasting engine 148. The plan and decisions are therefore always current with the execution data because they utilize the most recent state information.

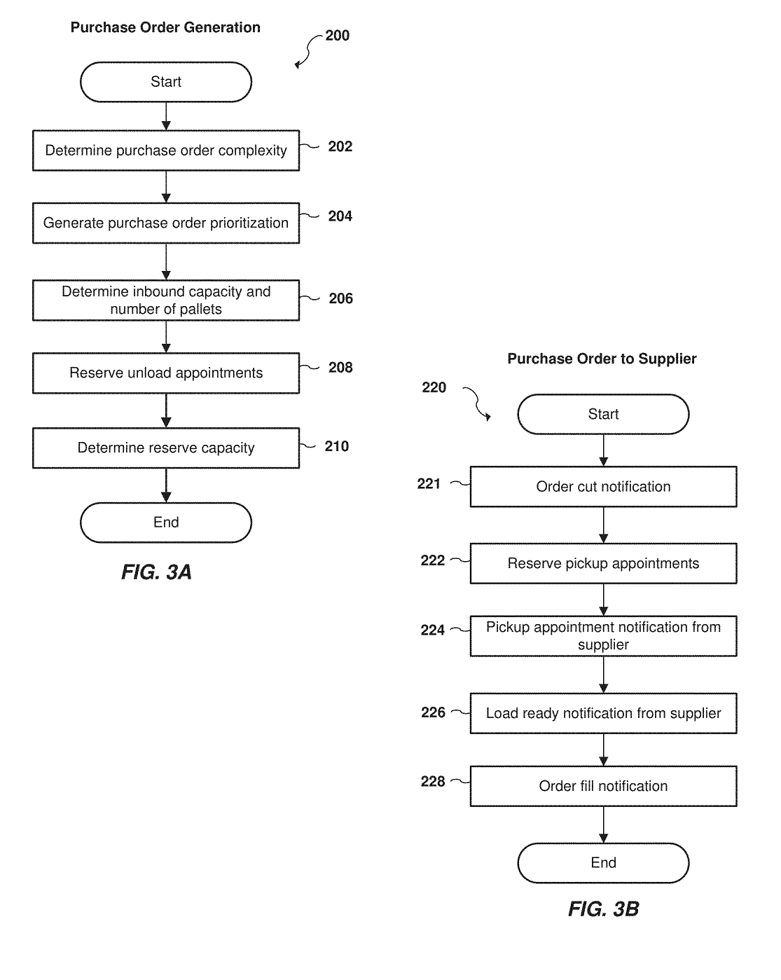

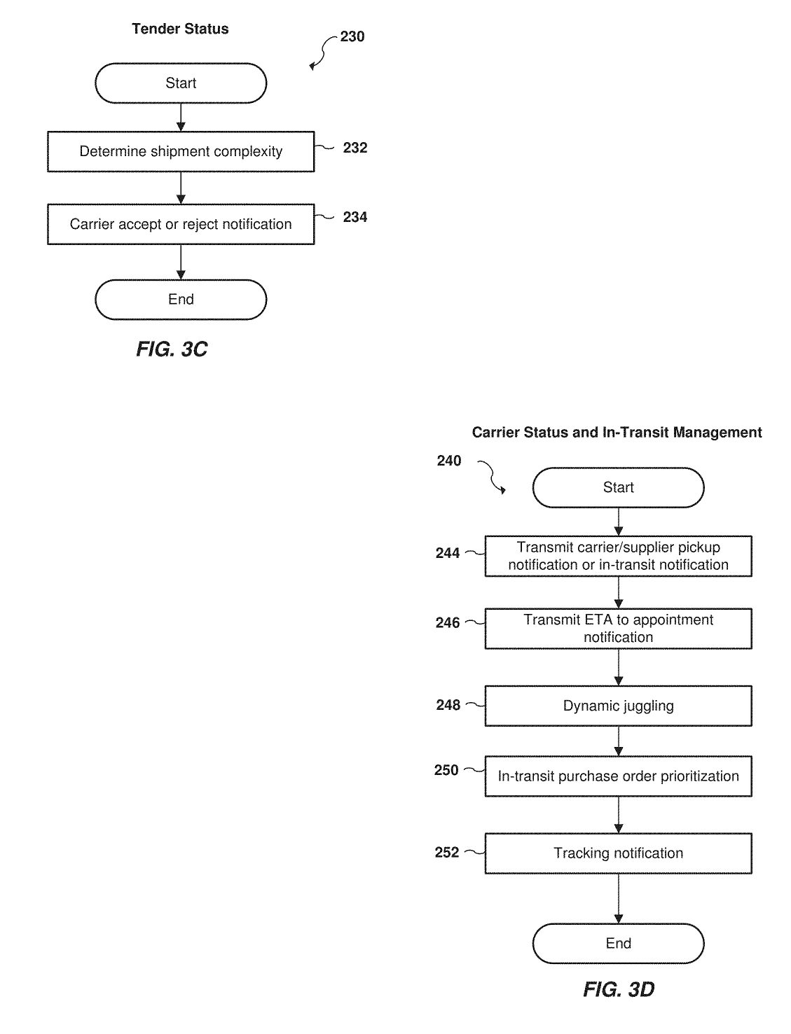

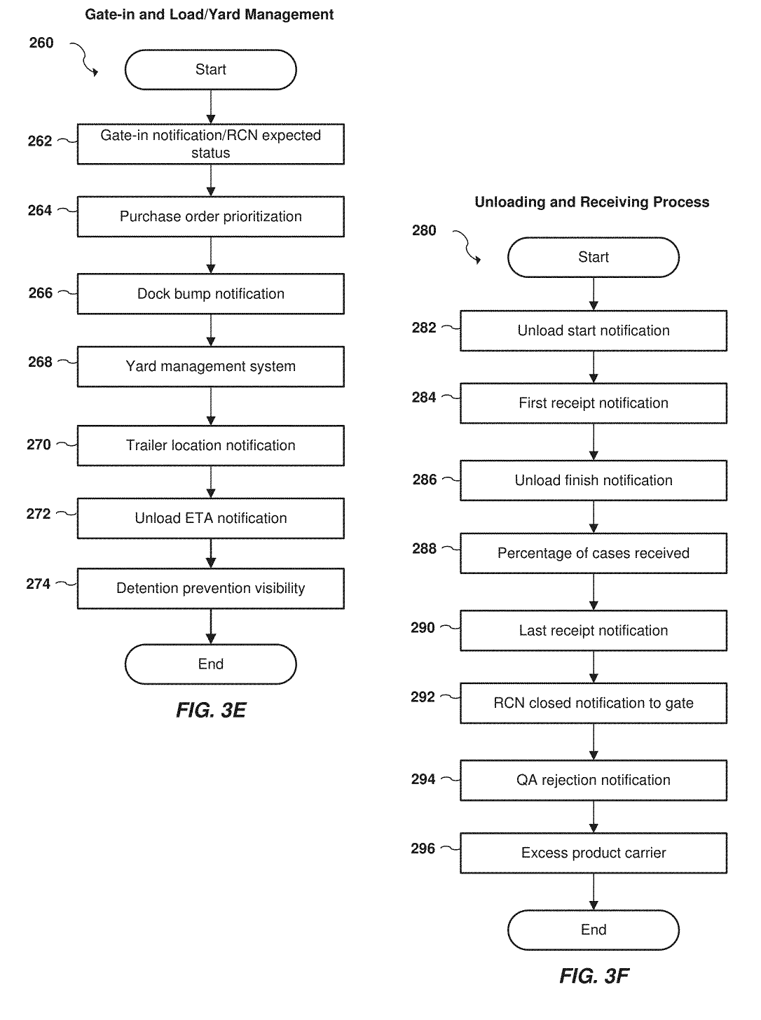

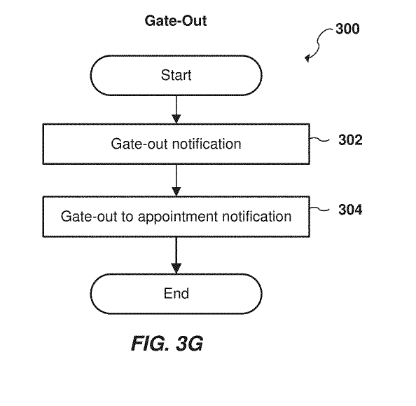

Referring to FIGS. 3A-3G, flow charts illustrating a method for optimized execution in a value chain network in accordance with an embodiment of the present invention, is shown.

FIG. 3A illustrates non-limiting purchase order generation processing 200. At block 202, the complexity of the purchase order is determined. The purchase order prioritization is generated at block 204. At block 206, inbound capacity and the number of pallets is determined. Unload appointments, if any, are reserved, at block 208. At block 210, reserve capacity is determined.

FIG. 3B illustrates non-limiting purchase order to supplier generation processing 220. At block 221, an order cut notification is sent to the supplier. Reserve pickup appointments are reserved, at block 222. At blocks 224 and 226, a pickup appointment notification and a load ready notification are sent from the supplier. An order fill notification is sent at block 228.

FIG. 3C illustrates non-limiting tender status processing 230. At block 232, the shipment complexity is determined. The carrier accepts or rejects the tender at block 234.

FIG. 3D illustrates non-limiting carrier status and in-transit management processing 240. At block 242, a carrier or supplier pickup notification or in-transit notification is transmitted. An appointment estimated time of arrival (ETA) notification is transmitted at block 244. At block 248, dynamic juggling occurs. In-transit purchase order prioritization occurs at block 250. At block 252, a tracking notification is sent.

FIG. 3E illustrates non-limiting gate-in and load or yard management processing 260. At block 262, a gate-in notification or a RCN expected status is sent. Purchase order prioritization occurs at block 264. At block 266, a dock bump notification is sent. Yard management occurs at block 268. At blocks 270 and 272, a trailer location notification and an unload ETA notification is sent. Detention prevention visibility occurs at block 274.

FIG. 3F illustrates non-limiting unloading and receiving processing 280. At blocks 282-286, an unload start notification, a first receipt notification and an unload finish notification, are respectively sent. The percentage of cases is received at block 288. At block 290-294, a last receipt notification, an RCN closes notification, and a QA rejection notification, are respectively sent. Excess product carrier processing occurs at block 296.

FIG. 3G illustrates non-limiting gate-out processing 300. At block 302, a gate-out notification is sent. A gate-out to appointment notification is sent at block 304.

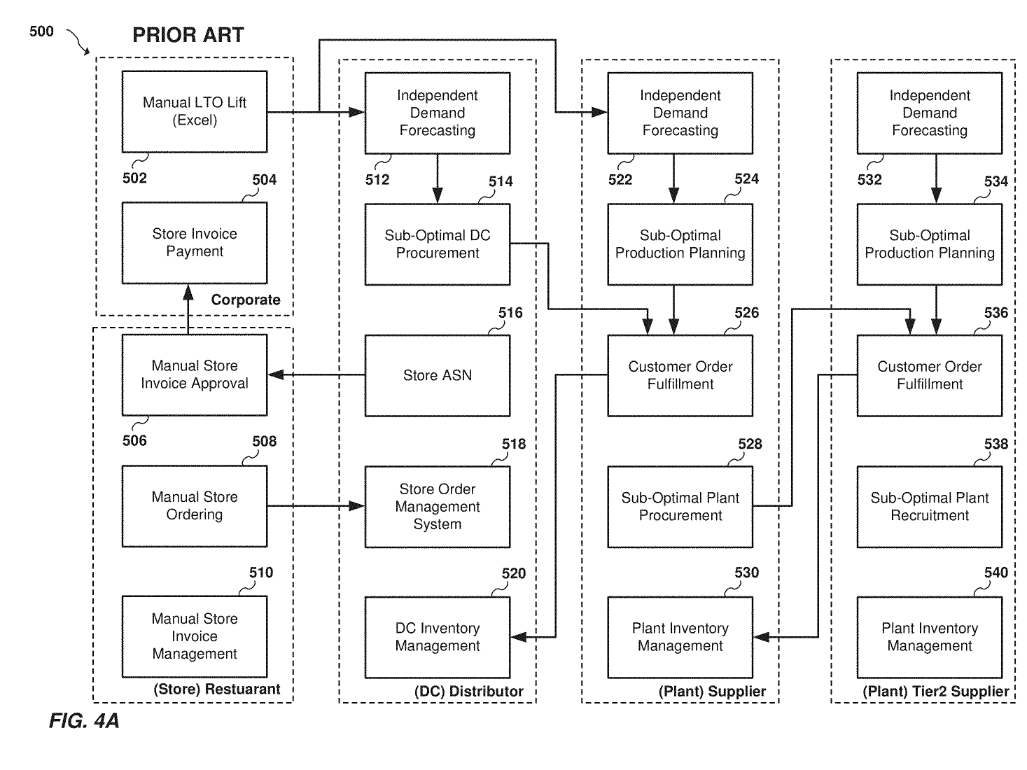

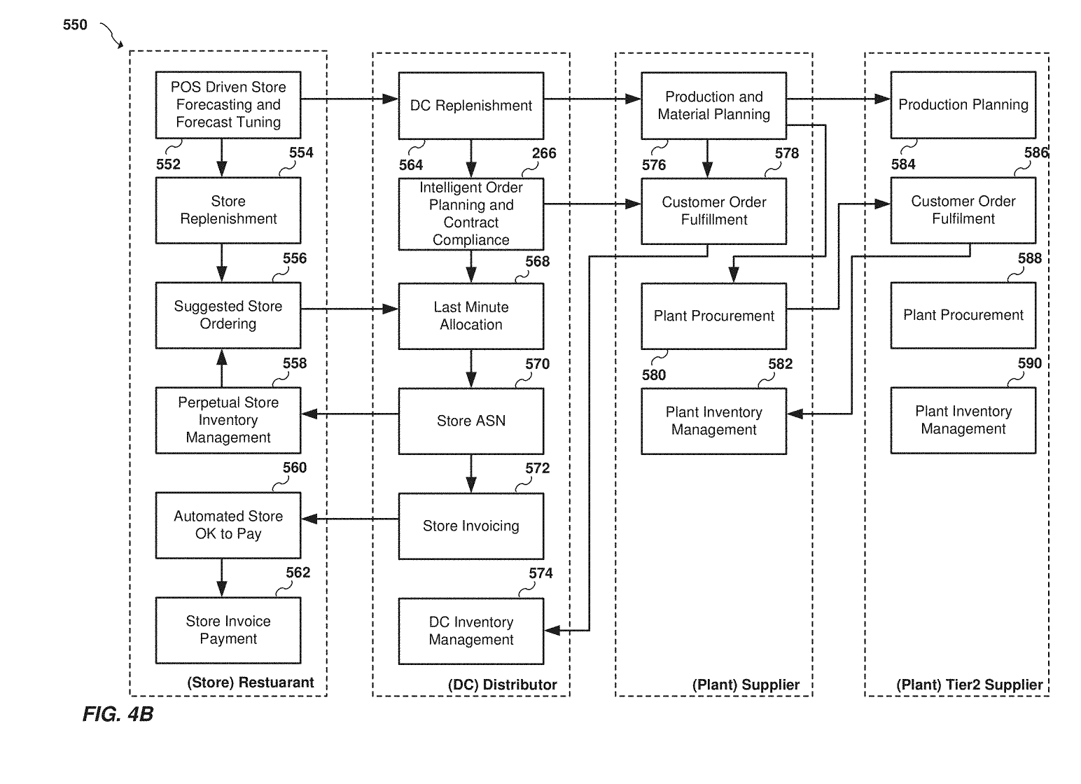

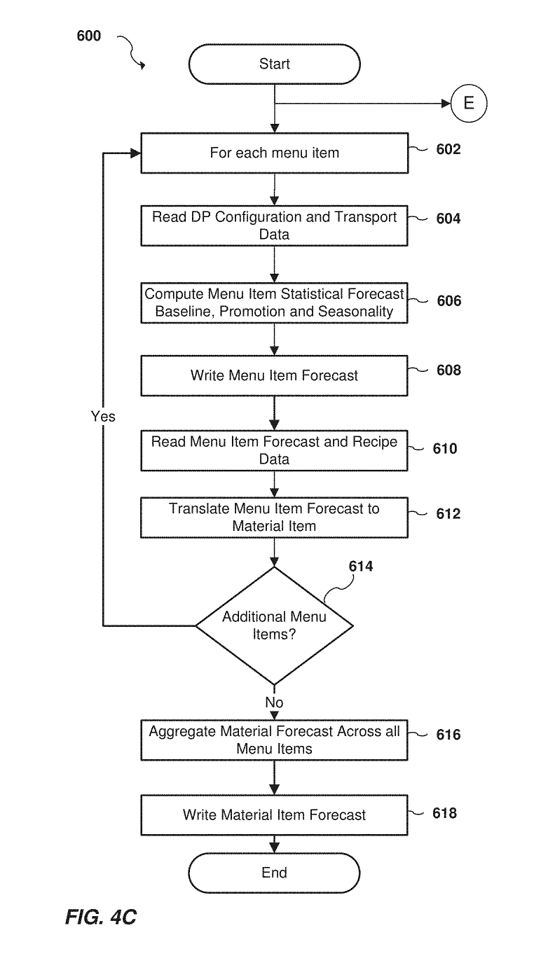

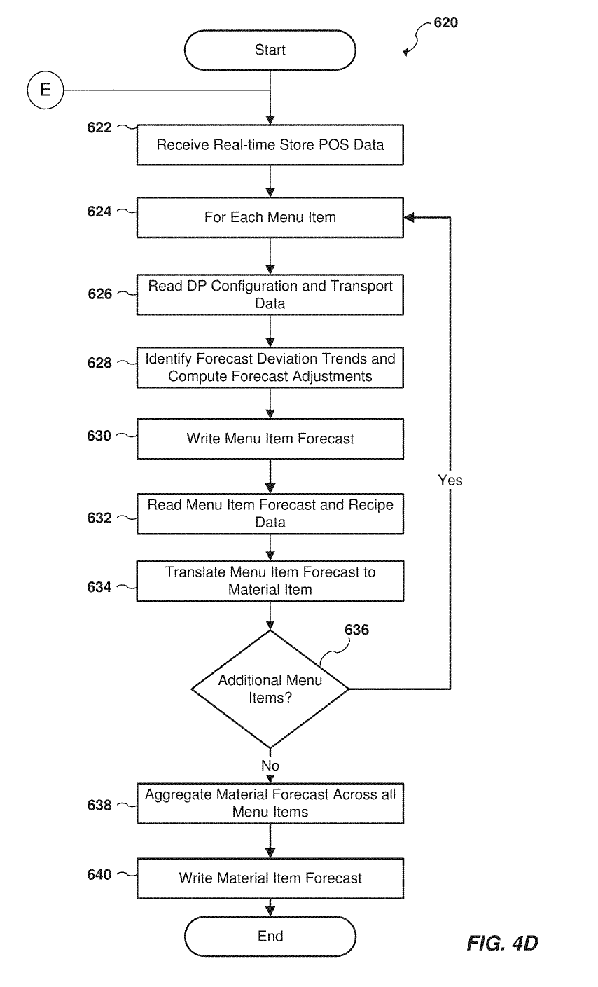

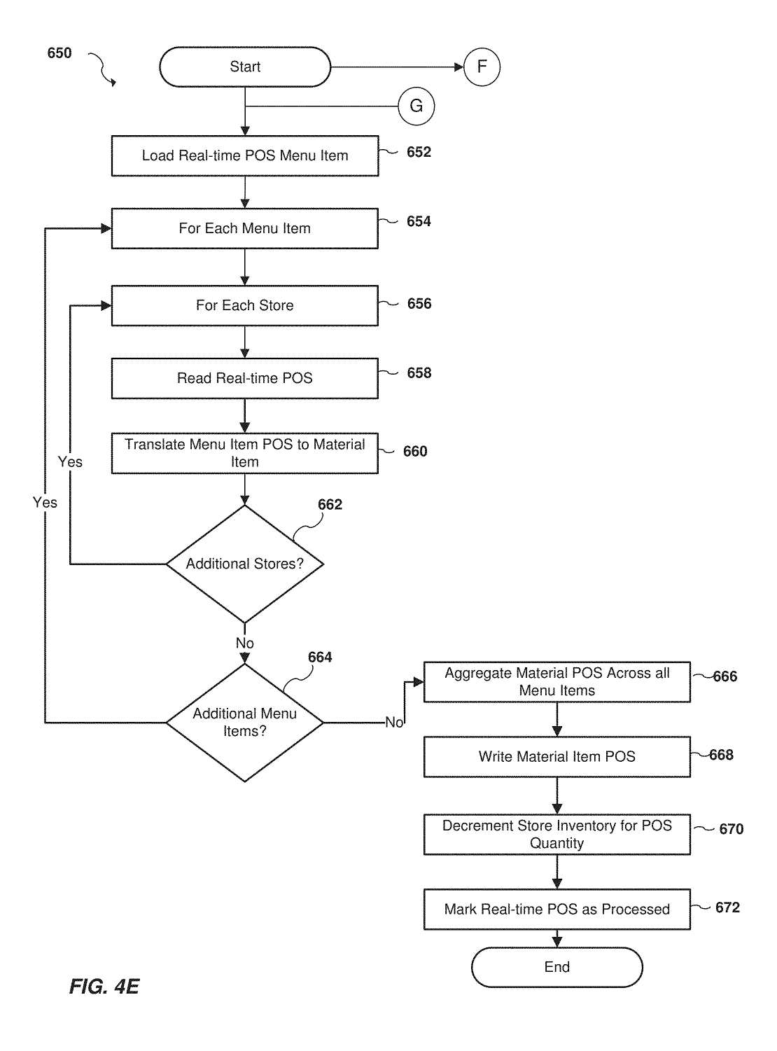

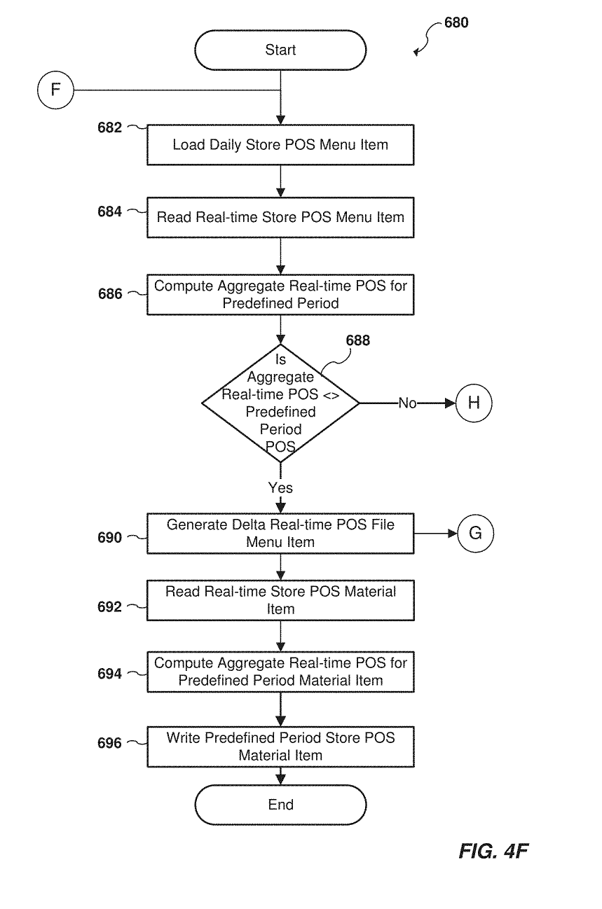

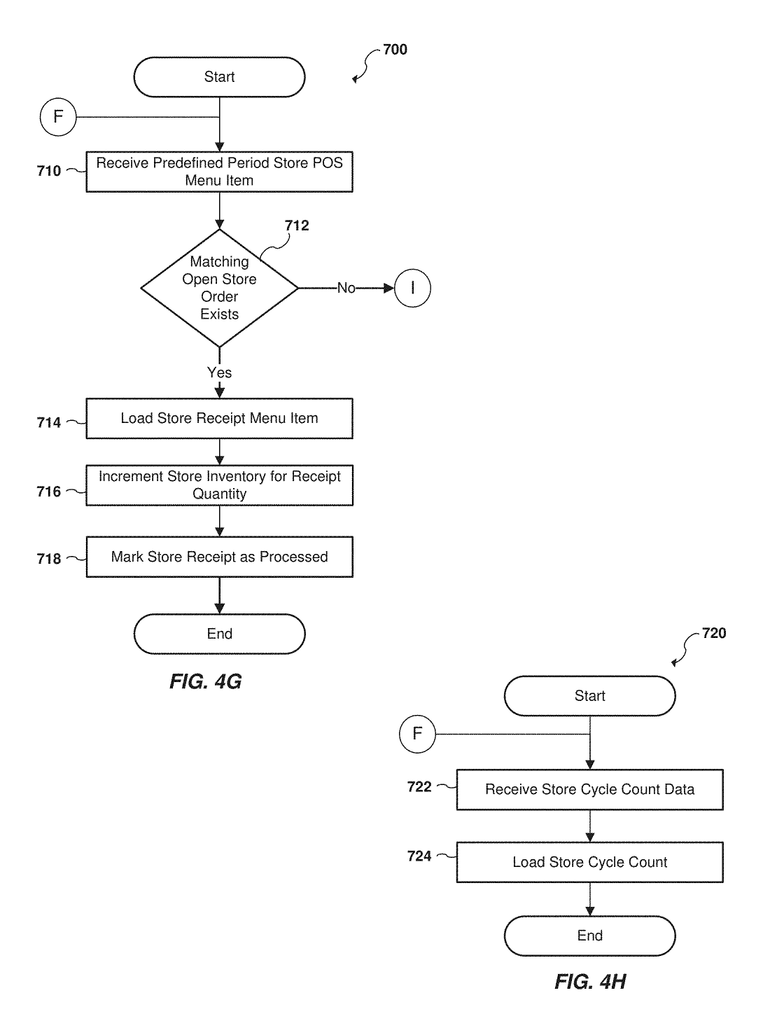

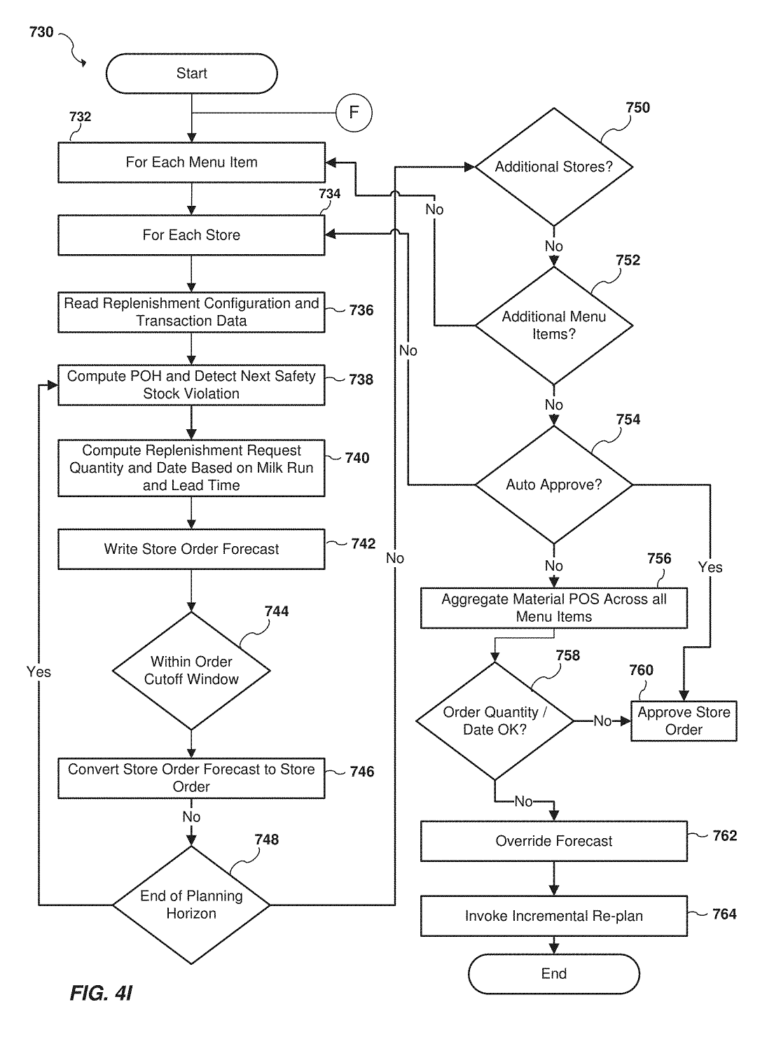

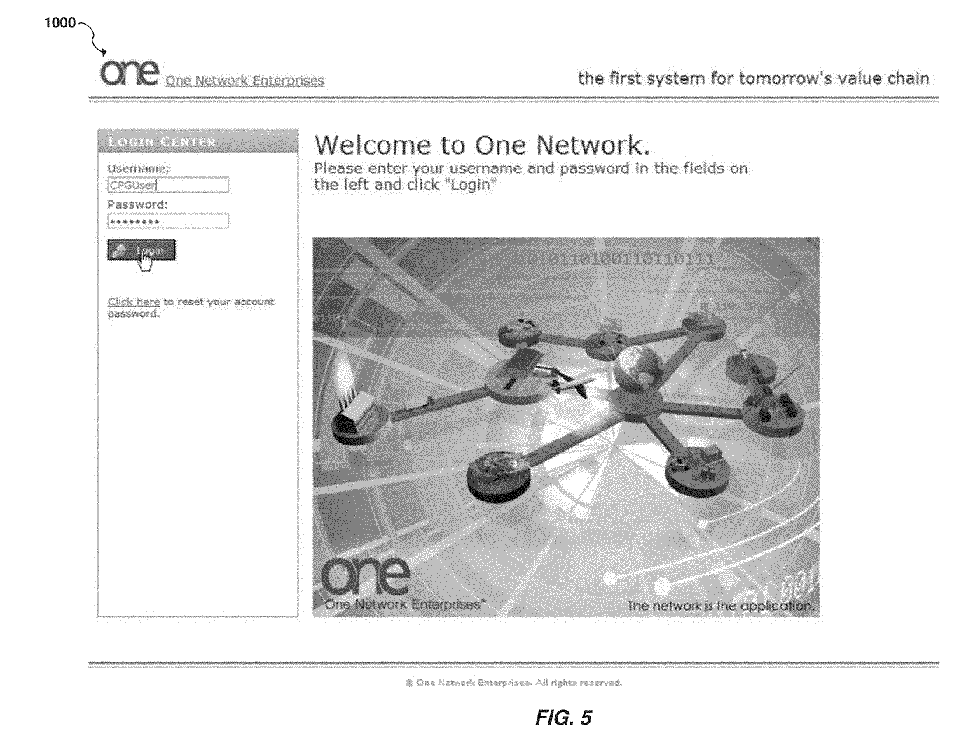

Referring to FIGS. 4A-4I, flow charts illustrating a method for optimized execution of handling raw product components used by a restaurant in a value chain network in accordance with an embodiment of the present invention, are shown. At block 602, a menu item is received. The DP configuration and transport data is read at block 604. At block 606, a menu item statistical baseline, promotion and seasonality forecast is computed. Menu item forecast is stored in the database at block 608. At block 610, menu item forecast and recipe date is read. The menu item forecast is translated into a material item at block 612. At decision block 614, a determination of whether there are any additional menu items exists occurs. If there are additional menu items, then processing continues with the next menu item at bock 602. Otherwise, a material forecast across all menu items is aggregated at block 616. At block 618, the material item forecast is output.

At block 622, real-time store point of sale (POS) data is received. At block 624, a menu item is received. The DP configuration and transport data is read at block 626. At block 628, the forecast deviation trends are identified and the forecast adjustments are determined. At block 630, the menu item forecast is stored in the database. The menu item forecast and the recipe data is read at block 632. At block 634, the menu item forecast is translated into material items. At decision block 636, a determination of whether there are any additional menu items exists occurs. If there are additional menu items, then processing continues with the next menu item at bock 624. Otherwise, a material forecast across all menu items is aggregated at block 638. At block 640, the material item forecast is output.

At block 652 real-time point-of-sale (POS) menu items data is loaded. A menu item for a store is received at blocks 654 and 656. At block 658, real-time POS information is read. The menu item POS is translated to material items at block 660. At decision block 662, a determination of whether there are any additional stores exists occurs. If there are additional stores, then processing continues with the next store at bock 656. Otherwise, at decision block 664, a determination of whether there are any additional menu items exists occurs. If there are additional menu items, then processing continues with the next menu item at bock 654. Otherwise, a material forecast across all menu items is aggregated at block 666, At block 668, material item point-of-sale (POS) data is stored in the database. The store inventory is decremented by the POS quantity at block 670. At block 672, the real-time POS is marked as processed.

At block 682, the daily store POS for the menu item is loaded. Real-time store POS menu item data is read at block 684. At block 686, real-time POS for a predefined period (e.g., an hour, 12 hours, a day, or any other predefined period) is aggregated. At decision block 688, a determination of whether the aggregate real-time POS is not equal to the POS for a predefined period occurs. If there is a difference, then a delta file is generated for the real-time POS menu item at block 690. At block 692, real-time store POS data for a material item is read. An aggregation for the real-time store POS data for a material item over a predefined period is computed at block 694. At block 696, the store POS material item over a predefined period is output.

At block 710, daily store POS for a menu item is received. At decision block 712, a determination of whether there are any matching open store orders exists occurs. If there are matching open store orders, then the store receipt menu item is loaded at block 714. At block 716, the store inventory is incremented by the receipt quantity. The store receipt is marked as processed at block 718.

At block 722, store cycle count data is received. Store cycle count is loaded at block 724.

A menu item for a store is received at blocks 732 and 734. At block 736, replenishment confirmation and transaction data is read. The POH is computed and the next stock violation is detected at block 738. At block 740, replenishment request quantity and date are computed based on milk run and lead time. The store order forecast is written to the database at block 742. At decision block 744, a determination of whether it within the order cutoff window period occurs. If it is within the order cutoff window period, then the store order forecast is converted into a store order at bock 746. At decision block 748, a determination of whether it is end of the planning horizon occurs. If it is end of the planning horizon, then at decision block 750, a determination of whether there are additional stores occurs. At decision block 752, a determination of whether there are additional menu items occurs. At decision block 754, a determination of whether there is an auto approval occurs. If there is no auto approval, then material POS is aggregated across all menu items. Otherwise, auto-approval of the store order occurs at block 760. At decision block 758, a determination of whether the order quantity and the date are acceptable occurs. At blocks 762 and 764, the forecast is overridden and an incremental re-plan is invoked.

The present invention may utilize or more computer applications. As used herein, a “computer application” is a computer executable software application of any type that executes processing instructions on a computer or embedded in a processor, and an “application” or “application project” are the files, objects, structures, database resources and other resources used in integrating a computer application into a software platform.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

This invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one of skill in the art, portions of the invention may be embodied as a method, device, or computer program product. Accordingly, portions of the present invention may take the form of an entirely hardware embodiment or an embodiment combining software and hardware aspects all generally referred to as a “circuit” or “module.”

The present invention includes a computer program product which may be hosted on a computer-usable storage medium having computer-usable program code embodied in the medium and includes instructions which perform the processes set forth in the present specification. The storage medium can include, but is not limited to, any type of disk including floppy disks, optical disks, CD-ROMs, magneto-optical disks, ROMs, RAMs, EPROMs, EEPROMs, flash memory, magnetic or optical cards, or any type of media suitable for storing electronic instructions.

Computer program code for carrying out operations of the present invention may be written in any programming language including without limitation, object oriented programming languages such as Java®, Smalltalk, C# or C++, conventional procedural programming languages such as the “C” programming language, visually oriented programming environments such as VisualBasic, and the like.

Obviously, many other modifications and variations of the present invention are possible in light of the above teachings. The specific embodiments discussed herein are merely illustrative, and are not meant to limit the scope of the present invention in any manner. It is therefore to be understood that within the scope of the disclosed concept, the invention may be practiced otherwise then as specifically described.

1. A computer program product embodied on a non-transitory computer readable medium for optimized execution of handling raw product components used by a restaurant in a value chain network, the value chain network having shared access to a shared database on a service provider computer over a network, wherein the computer program is implemented by one or more processors executing processor instructions, the computer program product comprising:
a first computer code for determining consumer traffic at a restaurant in the value chain network;
a second computer code for determining demand for one or more menu items from the restaurant in the value chain network, wherein determining the demand for the one or more menu items utilizes the determined consumer traffic;
a third computer code for determining demand for one or more raw product components associated with the one or more menu items from the restaurant in the value chain network, wherein determining the demand for the one or more raw product components utilizes the determined demand for the one or more menu items;
a forth computer code for receiving a request for an order for the one or more raw product components from the restaurant in the value chain network;
a fifth computer code for searching for one or more suppliers having matching one or more raw product components in the value chain network;
a sixth computer code for sourcing the matched one or more suppliers;
a seventh computer code for creating a plan over one or more segments to affect the movement of the one or more raw product components from a source location to a destination location, wherein the movement involves one or more carriers;
an eighth computer code for managing the handoffs between the restaurant, the one or more suppliers and the one or more carriers in order to ship the one or more raw product components;
a ninth computer code for receiving changes or anomalies to the plan over one or more segments; and
a tenth computer code for optimizing execution of the plan during its execution.

2. A computer program product embodied on a non-transitory computer readable medium for optimized execution in a value chain network, the value chain network having shared access to a shared database on a service provider computer over a network, wherein the computer program is implemented by one or more processors executing processor instructions, the computer program product comprising:
a first computer code for receiving a request for an order for goods or services from a first company in the value chain network;
a second computer code for searching for one or more second companies having matching goods or services in the value chain network;
a third computer code for sourcing the matched one or more second companies;
a fourth computer code for creating a plan over one or more segments to affect the movement of the good or services from a source location to a destination location, wherein the movement involves one or more third companies;
a fifth computer code for managing the handoffs between the relevant first, second and third companies in order to ship the goods or services;
a sixth computer code for determining demand for the goods or services from the first company in the value chain network;
a seventh computer code for receiving changes or anomalies to the plan over one or more segments; and
an eighth computer code for optimizing execution of the plan during its execution.

3. The computer program product of claim 2, wherein the service provider computer is a cloud computer.

4. The computer program product of claim 2, wherein the one or more second companies are suppliers of the goods or services.

5. The computer program product of claim 2, wherein the first company is a customer.

6. The computer program product of claim 2, wherein the computer program product further comprises a ninth computer code for providing visibility of the current state of the order to the relevant first, second and third companies over the value chain network.

7. The computer program product of claim 2, wherein the computer program product further comprises a ninth computer code for determining whether there is available supply or demand for the order.

8. The computer program product of claim 2, wherein the order includes one or more financial transactions, and wherein the computer program product further comprises a ninth computer code for providing initiation and confirmation of the one or more financial transactions.

9. A system for optimized execution in a value chain network, the system comprising:
a plurality of remote computers;
a central server;
a network interface in communication with the central server and the plurality of remote computers over a network, the network interface being configured to receive one or more transactions via the network, wherein the value chain network having shared access to a shared database on a service provider computer over a network via a database router module;
a shared database in communication with the central server;
wherein the central server is configured to:
receive a request for an order for goods or services from a first company in the value chain network;
search for one or more second companies having matching goods or services in the value chain network;
source the matched one or more second companies;
create a plan over one or more segments to affect the movement of the good or services from a source location to a destination location, wherein the movement involves one or more third companies;
manage the handoffs between the relevant first, second and third companies in order to ship the goods or services;
determine demand for the goods or services from the first company in the value chain network;
receive changes or anomalies to the plan over one or more segments; and
optimize execution of the plan during its execution.
